(19) United States
(12) Patent Application Publication
(10) Pub. No.: US 2012/0050293 A1
(43) Pub. Date: Mar. 1, 2012

(54) DYNAMICALLY SMOOTHING A CURVE

(75) Inventors: Alexandre Carlhian, Puteaux (FR); Guillaume Borios, Paris (FR); Laurent Baumann, Campbell, CA (US)

(73) Assignee: Apple, Inc., Cupertino, CA (US)

(21) Appl. No.: 12/868,506

(22) Filed: Aug. 25, 2010

(51) Int. Cl. G06T 11/20

(52) U.S. Cl. 345/442

(57) ABSTRACT

This is directed to dynamically adjusting the display of a curve provided on a display while the curve is being drawn. In particular, this is directed to identifying segments between sampled points of a line, and applying a transform to the segments to smooth the line between the sampled points. As additional points are identified, previously drawn segments can be transformed, displayed, and stored in cache. In some embodiments, the electronic device can monitor angles along the path to determine whether a user provided an instruction to draw a line having an intentionally sharp angle. In such cases, the electronic device can adjust the smoothing transform to maintain the sharp angle.

### BACKGROUND

Using an electronic device, a user can direct the device to display different types of content. For example, a user can direct the device to operate an application by which a user can provide a text input for display by the application (e.g., a word processing application). As another example, a user can direct the device to operate an application by which a user can define graphical elements for display. The graphical elements can include one or more shapes (e.g., predefined shape templates such as, for example, circles, squares, rectangles, polygons, or shapes having curved surfaces). Several graphical elements can be overlaid or combined to form complex graphical shapes and entities displayed by the device.

In some embodiments, a user can direct an electronic device to display a graphical element that includes a curved line. For example, a user can provide an input directing an application to draw a curved line on a display (e.g., a user provides a touch input on a touch surface, or a user controls a cursor moving on the display). The electronic device can detect a succession of points selected or identified by the user using any suitable approach. In some embodiments, the electronic device can detect individual points provided by a user at a predefined rate, or at a variable rate. The electronic device can provide any type of line between adjacent points. In some embodiments, the electronic device can define discontinuous segments between adjacent points. In some embodiments, the electronic device can process a completed line to define a smooth curve going through each of the points on the line.

While the user provides an input for drawing the line, however, the electronic device may not know how to draw a curved line through individual points selected by the user. The electronic device can instead initially display a sequence of distinct segments angled relative to one another at each interface between segments. Only once all of the points forming the line have been provided (e.g., once the user stops providing an input corresponding to an instruction to draw a line) can the electronic device apply a smoothing function to the drawn line to define a continuous or partially continuous line. This approach, however, can be limiting to a user, as a user may be required to stop drawing a line to determine the exact path of the line. When a user wishes to follow a predetermined path having several curved regions, a user may then be forced to guess at a path (e.g., use trial and error) or define a sequence of shorter, curved lines following the path that are later connected to each other, possible adversely affecting the smoothness of the interface between the shorter curved lines.

### SUMMARY

This is directed to systems, methods and computer-readable media for dynamically drawing a smooth curved line while a user defines additional points of the line. In particular, this is directed to applying a Bezier function to all but the last line segments of a line to preemptively smooth a curved line as the line is being drawn.

An electronic device can receive an instruction to a draw a curved line on a display from a user. As the user provides the instruction, the electronic device can detect a sequence of points or locations on the display through which the user wishes the line to go. The electronic device can detect points at any suitable rate including, for example, based on a time interval, motion detection, a user-provided instruction, or any other suitable interval.

Initially, the electronic device can connect adjacent points using straight line segments at an angle relative to one another. To allow the user to see a curve that more accurately represents the provided instruction in real time, the electronic device can define, for each segment, a curved line to replace the straight segment between the points. Successive curved lines can be selected to define a substantially smooth path between several points. In some embodiments, the electronic device can identify one or more segments, or one or more interfaces between segments for which it may be desirable not to provide a smooth curved line.

The electronic device can define a curved line to replace a segment using any suitable approach. In some embodiments, the electronic device can define a Bezier curve for a segment, where the detected points constitute ends of the Bezier curve, and control points defined by an algorithm based on the shape of the individual segments can provide intermediate points controlling the curvature and shape of the Bezier curve. The electronic device can consider any suitable number of segments before and/or after a particular segment for which a Bezier curve is defined. In some embodiments, the electronic device can consider three segments total (e.g., one before and one after the particular segment).

As the electronic device detects a point of the curve and defines a segment, the electronic device can define a new Bezier curve for the segment. In addition, the electronic device can adjust a Bezier curve for one or more (e.g., up to two) previous segments for which a Bezier curve was defined. The defined Bezier curves can be displayed instead of the initial segments to better illustrate the curve drawn by the user.

Based on the variables used for the Bezier curve, a Bezier curve defined for particular segment away from a changing end of the curve can remain the same as new points are detected for the curve. For example, a Bezier curve defined for any segment but the last two of the curve can be unchanged by additional segments added to the curve. To allow the curve to be smoothed dynamically without requiring intensive processing to re-draw or re-smooth the entire curve, the electronic device can store in cache all Bezier curves for segments other than those for which the calculated Bezier curves may still change (e.g., the last two). When a new segment is added, Bezier curves for the last two segments can be re-calculated based on the new segment, and at least one of the re-calculated Bezier curves can be provided to cache (e.g., the segment that is now one of the last three, and for which the calculated Bezier curve will not change). The Bezier curves for the last two segments can remain dynamically stored, as they may be adjusted based on additional segments of the curve.

In some embodiments, the electronic device can compare angles between adjacent segments to determine whether a user intended to draw a sharp angle in the curve (e.g., an angle that should not be rounded). For example, the electronic device can determine whether an angle between segments is within a threshold amount of 180 degrees (e.g., pi radians). If the electronic device determines that the angle is not within the threshold amount, the electronic device can retain the sharp angle, and smooth the segments before and after the angle using a Bezier transformation.

### BRIEF DESCRIPTION OF THE DRAWINGS

The above and other features of the present invention, its nature and various advantages will be more apparent upon consideration of the following detailed description, taken in conjunction with the accompanying drawings in which:

FIG. 1 is a schematic view of an illustrative line drawn by a user and displayed as a sequence of straight line segments in accordance with one embodiment of the invention;

FIG. 2 is a schematic view of an illustrative line having curved segments between points in accordance with one embodiment of the invention;

FIGS. 3A and 3B are schematic views of an illustrative curve as it is modified while a user provides an instruction to draw the curve in accordance with some embodiments of the invention;

FIG. 4 is a flowchart of an illustrative process for defining transformed segments for a line as the line is drawn in accordance with one embodiment of the invention;

FIG. 5 is a schematic view of a portion of a line to which a transform is applied in accordance with one embodiment of the invention;

FIG. 6 is a schematic view of a portion of another line to which a transform is applied in accordance with one embodiment of the invention;

FIG. 7 is a schematic view of a portion of a line having a sharp angle in accordance with one embodiment of the invention;

FIG. 8 is a flowchart of an illustrative process for applying a Bezier transform to a particular segment of a line in accordance with one embodiment of the invention;

FIG. 9 is a flowchart of an illustrative process for displaying curved segments between points defining a line in accordance with one embodiment of the invention; and

FIG. 10 is a schematic view of an illustrative electronic device for executing a preview application in accordance with one embodiment of the invention.

### DETAILED DESCRIPTION

This is directed to seamlessly smoothing out in real time curves drawn on a display by a user. In particular, this is directed to applying a Bezier transform to individual segments of a curve to round the curve as the curve is drawn.

Using input interfaces of electronic device, a user can provide different types of inputs to the device. In some cases, users can provide textual inputs, such that text characters (e.g., letters, number and symbols) selected by a user appear on a device display. In some cases, a user can instead or in addition provide an input for selecting one or more options provided by a device, for example on a display. In still other cases, a user can provide an instruction for displaying non-textual elements on a display. For example, a user can provide an instruction for displaying one or more graphical elements on a display including, for example, shapes or linear elements. In some cases, a displayed shape can be defined as a combination of several linear elements that intersect, or as a pre-defined closed line pattern.

A user can direct a device to display a linear graphical element using several different approaches. In some embodiments, a user can direct an electronic device to implement an application for drawing graphical elements on the display. Using the application, the user can select one or more drawing tools and corresponding settings to draw a graphical element on the display. For example, a user can select a line type, thickness, color, sample rate, or other properties of a defined line element. Using the drawing tool, a user can select a start point for the line element, and provide a sequence of inputs defining a path for the line element from the start point using an input interface. For example, the user can control the movement of a cursor or other line drawing tool from the start point to an end point along a user defined path.

As the user provides an input corresponding to the path of the line element, the electronic device can sample individual points over time to define the line. The electronic device can sample points at any suitable rate including, for example, a constant rate or a variable rate. In some cases, points can be sampled at predefined time intervals (e.g., every 100 ms), intervals selected based on the distance covered (e.g., a maximum number of pixels or measured distance between points), based on the output of a motion sensing component (e.g., in response to detecting a particular amount of movement), or combinations of these. The electronic device can store a sequence of points using any suitable approach including, for example, in a list or array of coordinates.

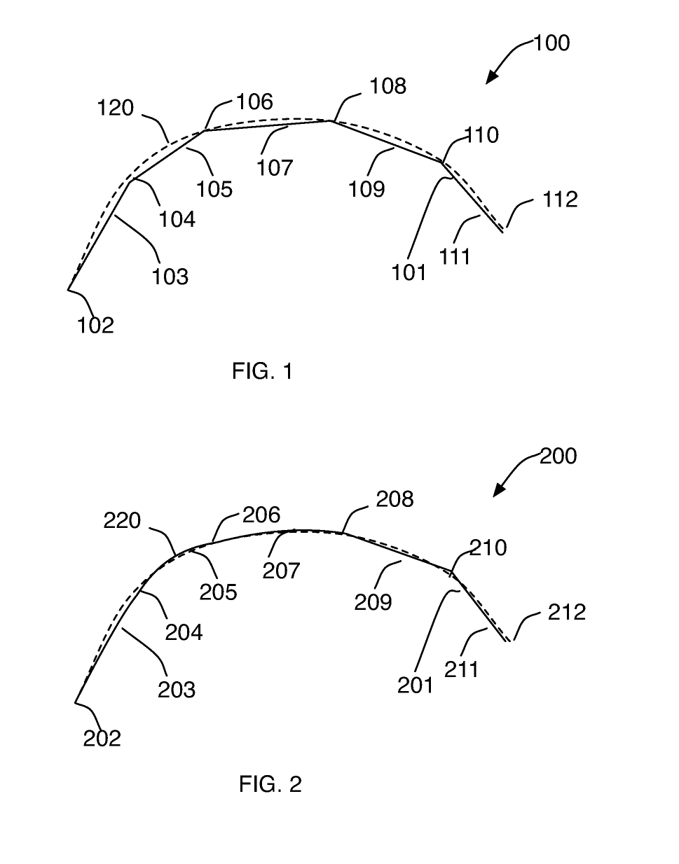

As the electronic device defines individual points of a line, the electronic device can display several lines connecting the defined points. In some cases, the electronic device can initially drawn and display straight lines between the points. FIG. 1 is a schematic view of an illustrative line drawn by a user and displayed as a sequence of straight line segments in accordance with one embodiment of the invention. Display 100 can be provided by any suitable application or operation of an electronic device including, for example, an application for drawing graphical elements. The user can provide an input corresponding to curved line 120, which the electronic device can detect and store as a sequence of points. For example, the electronic device can identify points 102, 104, 106, 108 and 112. The particular points identified for the line can be spaced at any suitable distance as determined from the sample rate used by the device to identify the path provided by the user. In the example of FIG. 1, the points are substantially equidistant, which can indicate a relatively constant speed of motion for the user's input.

The electronic device can connect the individual points to draw a line on the display. In particular, the electronic device can provide straight line segment 103 between points 102 and 104, segment 105 between points 104 and 106, segment 107 between points 106 and 107, segment 109 between points 108 and 110, and segment 111 between points 110 and 112. The combined straight line segments can define line 101, which the electronic device can display to approximate curved line 120 provided by the user.

The electronic device can use one of several approaches to replace line 101 with a line that more closely matches line 120. In one implementation, the electronic device can increase the sample rate for individual points on the line. By identifying additional points along line 120, the electronic device can draw a larger number of straight line segments that are shorter, and therefore more closely match the shape of curve 120. This approach, however, can require more processing and storage resources, which can restrict the usefulness of the device. Alternatively, the electronic device can apply a transformation to line 101 to replace the combination of segments with a continuous curved line. For example, the electronic device can identify the sequence of points corresponding to line 120, and apply a Bezier transform to the points to define a Bezier curve based on the sequence of points. The resulting Bezier curve can then more accurately represent a line corresponding to the user's input. This approach, however, requires the entire line to be completed before the transform can be applied. The user may therefore not know how the device will draw the curved representation until the user provides an indication that the line is finished.

To improve a user's ability to accurately draw curved lines as desired, the electronic device can instead replace individual segments of a line with curved lines while the user continues to provide inputs corresponding to a curved line (e.g., as the user continues to draw the line). FIG. 2 is a schematic view of an illustrative line having curved segments between points in accordance with one embodiment of the invention. Display 200 can be provided by any suitable application or operation of an electronic device including, for example, an application for drawing graphical elements. The user can provide an input corresponding to curved line 220, which the electronic device can detect and store as a sequence of points. For example, the electronic device can identify points 202, 204, 206, 208 and 212, which can be defined using the same or different approaches as those used for identifying the points of the line of FIG. 1. The electronic device can define line segments between the individual points to define line 201. In particular, line 201 can include line segment 203 between points 202 and 204, segment 205 between points 204 and 206, segment 207 between points 206 and 207, segment 209 between points 208 and 210, and segment 211 between points 210 and 212.

In contrast with the approach shown in FIG. 1, at least some of the segments of line 201 can be curved to approach portions of line 220. In particular, the electronic device can dynamically adjust one or more segments between identified points to provide a curved line segment as the user continues to draw line 220. The electronic device can dynamically adjust any suitable number or subset of line segments including, for example, all line segments starting from the beginning of line 220 up to a particular number of line segments from the last identified point of the line. In the implementation shown in FIG. 2, the electronic device can revise the shape of line segments 203, 205 and 207, but maintain the last two segments of the line (e.g., segments 209 and 211) as straight segments. The particular number of segments that are not adjusted can be selected using any suitable approach including, for example, the criteria or arguments used in the function or transform applied to the line segments. In one implementation, a transform can be applied to all but the last two segments of a line. The transform can require any suitable information before it can be completely applied to a line segment including, for example, the positions of one or two points defining the line after the line segment.

In an alternative approach, the electronic device can instead or in addition incompletely apply a transform to one or more of the segments of the line for which straight segments are provided. In particular, the electronic device can define temporary curved lines based on the output of a transform, where some of the arguments required for the transform are not available. For example, if the transform requires the two points following a particular segment to adjust the segment (e.g., adjust segment 209 only if point 212 and an additional point are known), the electronic device can apply the transform to the segment based on incomplete arguments, and later adjust the segment when the missing arguments become available (e.g., adjust segment 209 once another point is defined by the device). Using this approach, the electronic device can store in cache the curved lines for which sufficient information is available to apply the transform, and for which the transformed curved lines will not change as the device defines more points of the line based on the user's input. The segments for which the transformed curved line can change can be re-calculated each time a new point is defined (e.g., when sufficient points are detected to apply the transform) until the final curved line is defined, at which time the final curved line can be added to the cache.

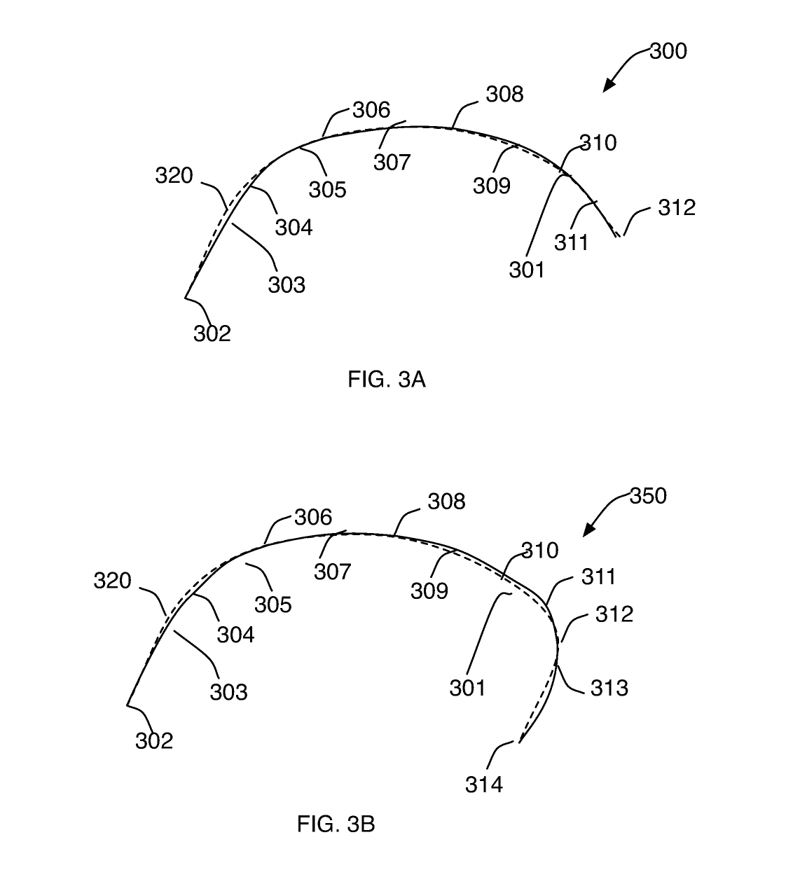

FIGS. 3A and 3B are schematic views of an illustrative curve as it is modified while a user provides an instruction to draw the curve in accordance with some embodiments of the invention. Display 300, shown in FIG. 3A, can be provided by any suitable application or operation of an electronic device including, for example, an application for drawing graphical elements. The user can provide an input corresponding to curved line 320, which the electronic device can detect and store as a sequence of points. For example, the electronic device can identify points 302, 304, 306, 308 and 312, which can be defined using the same or different approaches as those used for identifying the points of the line of FIG. 1. The electronic device can define line segments between the individual points to define line 301. In particular, line 301 can include line segment 303 between points 302 and 304, segment 305 between points 304 and 306, segment 307 between points 306 and 308, segment 309 between points 308 and 310, and segment 311 between points 310 and 312. Line segments 303 and 305 can be curved line segments completely defined by applying a transform to a straight segment between the corresponding endpoints of the segments, and can therefore be stored in cache. Line segments 307, 309 and 311 can be curved line segments defined by partially applying a transform to straight segments between the corresponding endpoints of the segments. In particular, the transform applied to line segments 307, 309 and 311 can require the position of additional points of the line to have all of the arguments required to completely apply the transform to the line segments. When additional points are defined as part of line 320, the result of the transform applied to line segments 307, 309 and 311 can change, and can therefore be re-calculated.

Display 350, shown in FIG. 3B, can include line 320 corresponding to a user's instructions, and line 301 drawn on the device display, having some or all of the same features and attributes as the corresponding lines of FIG. 3A. In contrast with display 300, however, display 350 can include additional point 314 defined when the user continued to provide an input for defining line 320. The electronic device can draw an additional line segment 313 between points 312 and 314. By virtue of the additional point, the electronic device can completely apply the transform to segment 307 (e.g., now that there are enough points to provide for all arguments of the transform) and define a final curved line segment 307 to be stored in cache. The resulting line segment may be relatively similar or different from the segment calculated by the transform before receiving the additional point. In the example of FIGS. 3A and 3B, however, the segment of FIG. 3B (e.g., after the complete transform is applied) can be closer to line 320 than the segment of FIG. 3A.

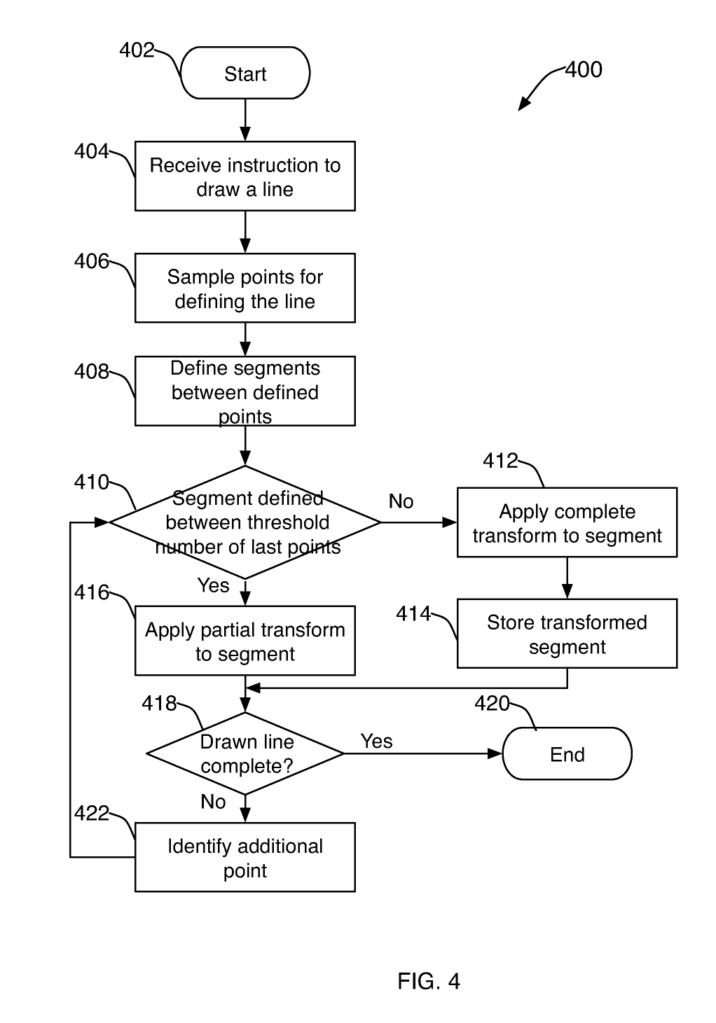

FIG. 4 is a flowchart of an illustrative process for defining transformed segments for a line as the line is drawn in accordance with one embodiment of the invention. Process 400 can begin at step 402. At step 404, an electronic device can receive an instruction to draw a line. For example, the electronic device can receive an input from an input interface defining a path for a line. As another example, the electronic device can receive an input for providing a graphical element that includes at least one line having a shape set by the user. At step 406, the electronic device can sample points for defining the line. For example, the electronic device can identify a sequence of points describing the path of the user-defined line. The electronic device can sample points for the line at any suitable rate including, for example, a constant or variable rate.

At step 408, the electronic device can define segments between the defined points. For example, the electronic device can define a straight or curved line segment between adjacent defined points. In some cases, the electronic device can define a line segment between several points (e.g., define a segment between three consecutive points). At step 410, the electronic device can determine whether a segment is defined between two points that are within a threshold number of the last defined points. For example, the electronic device can select a segment, and determine whether the points providing the end points of the segment are among the last points (e.g., the last three or four defined points of the line). In some embodiments, steps 408 and 410 can instead or in addition be replaced by a step that selects two adjacent points and determines whether the points are among the last points of the line. The electronic device can then define a segment between the points at a later step of process 400. If the electronic device determines that a segment is defined between two points that are not within a threshold number of the last defined points, the electronic device can move to step 412.

At step 412, the electronic device can apply a complete transform to the segment. For example, the electronic device can apply a transform (e.g., a Bezier transform) for which the arguments required to apply the transform to the segment are all known. In some embodiments, the electronic device can display the transformed segment between the points. At step 414, the electronic device can store the transformed segment. For example, the electronic device can store the transformed segment in cache, where it can be re-used without needing to be re-defined (e.g., the transform need not be re-applied to the segment). Process 416 can then move to step 418, described below.

If, at step 410, the electronic device instead determines that a segment is defined between two points that are within a threshold number of the last defined points, the electronic device can move to step 416. At step 416, the electronic device can apply a partial transform to the segment. For example, the electronic device can apply a transform to the segment for which only some of the required arguments are known. In particular, an argument defined by as of yet undefined subsequent points of the line (e.g., the device has not yet sampled the subsequent points defining the line) may not be available to the transform. In some embodiments, the electronic device can display the partially transformed segment. At step 418, the electronic device can determine whether the drawn line is complete. For example, the electronic device can determine whether the user has provided an input corresponding to an instruction to stop drawing the line. If the electronic device determines that the drawn line is complete, process 400 can move to step 420 and end. In some embodiments, the electronic device can store all completely and partially transformed segments defining the line in response to determining that the line is complete. In some embodiments, the electronic device can instead or in addition apply a new transform to the entire, complete line (e.g., to the entire collection of defined points) to replace the individual segments defined while the line was being drawn.

If, at step 418, the electronic device instead determines that the drawn line is incomplete, the electronic device can move to step 422. At step 422, the electronic device can identify an additional point for the line. For example, the electronic device can define an addition sampled point for the line. By virtue of the additional point, the segment may no longer be defined by two points that are within a threshold number of the last defined points. Accordingly, process 400 can return to step 410, and re-apply the transform to the segment. Accordingly, a partial transform of a segment (e.g., determined at step 416) may not be stored in cache, but may instead be re-calculated each time new points are defined for a line until the segment is no longer among the last segments of the line.

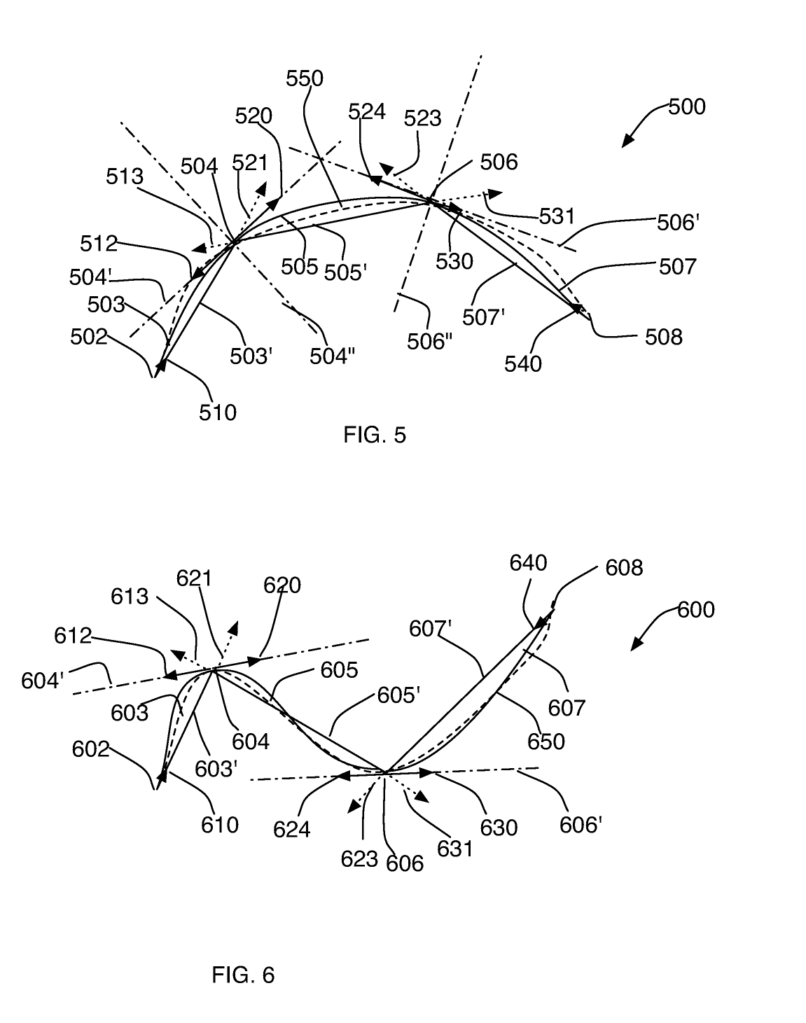

The electronic device can apply any suitable transform to segments defined between adjacent points. The following discussion will describe a particular transform, though it will be understood that any other process by which a straight line segment can be replaced by a curved segment defined to resemble a line corresponding to a user input can be used. FIG. 5 is a schematic view of a portion of a line to which a transform is applied in accordance with one embodiment of the invention. Display 500 can include line 501 constructed from the combination of segments 503, 505 and 507. Points 502, 504, 506 and 508, which can be identified by sampling as a user provides an input corresponding to line 550, can define line 501.

Each of segments 503, 505 and 507 can be constructed by applying a transform to straight line segments 503′, 505′ and 507′, respectively. In some embodiments, a quadratic Bezier transform can be applied to each segment between adjacent points of the line drawn by the user. A quadratic Bezier transform can require four distinct points to serve as arguments to define a Bezier curve. End points for a segment can serve as two of the points used for the Bezier transform (e.g., start and end points of the Bezier curve). The remaining two points can be selected based on adjacent segments within the line, which can serve to define the curvature of the Bezier curve. In particular, the remaining two points can serve to determine the manner in which the curve extends from an end point (e.g., defines a tangent for the curve at the end point, and a distance from the end point by which the curve must extend before curving towards the opposite end point). In some embodiments, it may be desirable to define each the remaining two points on a line that is shared with the application of the transform to an adjacent segment so that the adjacent curved segments can be tangent to a single line at their interface, and thereby provide a smooth curve.

Segment 503 can be constructed using a quadratic Bezier transform. Points 502 and 504 can serve as end points for the Bezier transform, as this approach can ensure that Bezier transforms of adjacent segments form a continuous line. To determine the control points defining the curvature of the Bezier transform, the electronic device can identify attributes of the segments preceding and following segment 503. Because segment 503 can include a first segment of the line, first control point 510 can be selected to substantially be the same (or be the same) as point 502. In particular, first control point 510 can be selected to be on segment 503′, at a point along the segment that is substantially near or the same as point 502 (e.g., a point defined as a control value multiplied by the length of segment 503′, or as a control value times 0, the length of a non-existent segment preceding segment 503′).

The electronic device can define second control point 512 by defining a line that is substantially perpendicular to the line bisecting the angle between segments 503′ and 505′. In particular, the electronic device can construct control line 504′ by first defining line 504″ bisecting the angle between segments 503′ and 505′, and subsequently defining control line 504′ perpendicular to bisecting line 504″ and passing through point 504. The electronic device can then select point 512 along control line 504′, where point 512 is at a particular distance from end point 504. The electronic device can calculate the distance using any suitable approach including, for example, selecting a constant distance (e.g., a number of pixels along the control line), a distance related to the length of segment 505′ or of segment 503′, or a combination of these. In one implementation, the distance can be selected by multiplying a control value (e.g., the same control value as that selected for control point 510) and the length of segment 505′ following segment 503′. Point 512 can be positioned on any suitable portion of control line 504′ relative to point 504. In one implementation, point 512 can be placed on the portion of control line 504′ that extends towards from segment 503′ relative to line 504″ (e.g., the portion of control line 504′ that extends in the same direction as line 505′ extended away from point 506 and towards point 502).

In some embodiments, control line 504′ can instead or in addition be constructed by extending one or both of segments 503′ and 505′. For example, the electronic device can extend segment 505′ past point 504 and away from point 506 (e.g., towards point 502) to define extension 513. As another example, the electronic device can extend segment 503′ past point 504 and away from point 502 (e.g., towards point 506) to define extension 521. The angles between extension 513 and segment 503′, and between extension 521 and segment 505′ can be the same (e.g., by virtue of the construction of the extensions). In addition, if bisecting line 504″ divides the angle between segments 503′ and 505′, by construction, control line 504′ also bisects the angles between extension 513 and segment 503′, and between extension 521 and segment 505′ (e.g., control line 504′ creates half angles within the angles formed between the straight segments and the extensions). Therefore, the electronic device can define control line 504′ as the line for which the angles between control line 504′ and extension 513, between control line 504′ and line 503′, between control line 504′ and line 505′, and between control line 504′ and extension 521 are the same. By defining one or both of extension 513 and 521, the electronic device can therefore quickly define control line 504′.

Segment 505 can be constructed using a quadratic Bezier transform. Points 504 and 506 can serve as end points for the Bezier transform, as this approach can ensure that Bezier transforms of adjacent segments form a continuous line. Similar to the transform used for segment 503, the electronic device can identify attributes of the segments preceding and following segment 505 to determine control points to use in the Bezier transform. The electronic device can define first control point 520 by defining control line 504′ bisecting the angle between extension 521 of segment 503′ towards point 506 and away from point 502 and segment 505′. Similarly, the electronic device can define second control point 522 by defining control line 506′ bisecting the angle between extension 523 of segment 507′ (e.g., the following segment in the line) towards point 504 and away from point 508 and segment 505′. The electronic device can determine the position of the control points along each of the control lines using any suitable approach. In some embodiments, the electronic device can define a distance from the end points for each of the control points. The distance can be the same or different for each of control points 520 and 522. In some embodiments, the position control points can be defined from a control value (e.g., point 520 is positioned at a distance equal to the control value multiplied by the length of segment 503′, and point 522 is positioned at a distance equal to the control value multiplied by the length of segment 507′). In some embodiments, the control point distance can be selected based on the intersection of control lines 504′ and 506′. For example, the control point distance can be selected to be the point of intersection of the control lines, or a control value multiplied by the distance from points 504 and 506 to the point of intersection.

Segment 507 can be constructed using a quadratic Bezier transform. Points 506 and 508 can serve as end points for the Bezier transform, as this approach can ensure that Bezier transforms of adjacent segments form a continuous line. Similar to the transform used for segment 503, the electronic device can identify attributes of the segments preceding and following segment 507 to determine control points to use in the Bezier transform. The electronic device can define first control point 530 by defining control line 506′ bisecting the angle between extension 531 of segment 505′ towards point 508 and away from point 506 and segment 507′. The electronic device can determine the position of the control point along the control lines using any suitable approach. In some embodiments, the electronic device can define a distance from end point 506 for control point 530 (e.g., based on a control value multiplied by the length of segment 505′). Because segment 507 can include a last segment of the line, second control point 532 can be selected to substantially be the same (or be the same) as point 508. In particular, first control point 510 can be selected to be on segment 507′, at a point along the segment that is substantially near or the same as point 508 (e.g., a point defined as a control value multiplied by the length of segment 507′, or as a control value times 0, the length of a non-existent segment following segment 507′).

FIG. 6 is a schematic view of a portion of another line to which a transform is applied in accordance with one embodiment of the invention. Display 600 can include line 601 constructed from the combination of segments 603, 605 and 607. Points 602, 604, 606 and 608, which can be identified by sampling as a user provides an input corresponding to line 650, can define line 601. To transform straight segment 603′ to curved segment 603, straight segment 605′ to curved segment 605, and straight segment 607′ to curved segment 607, the electronic device can apply a quadratic Bezier transform, as described above. In particular, the electronic device can define control points 610 and 612 using no control line and control line 604′, respectively, for constructing the transformed segment 603. The electronic device can define control points 620 and 622 using control lines 604′ and 606′, respectively, for constructing the transformed segment 605. The electronic device can define control points 630 and 632 using control line 606′ and no control line, respectively, for constructing the transformed segment 607. Control line 604′ can be constructed using extensions 613 and 621, and control line 606 can be constructed using extensions 623 and 631, where the control lines bisect angles corresponding to the extensions (e.g., as described above in connection with display 500, FIG. 5). Unlike the line of display 500, which forms a concave path, the line of display 600 forms a path having a concave section and a convex section. The electronic device can nevertheless provide an appropriate sequence of curved Bezier transforms by the proper construction of the control points.

In some embodiments, a higher order Bezier transform can be used instead of or in addition to a second order (e.g., quadratic) Bezier function. For example, an electronic device can identify more than two successive or consecutive points in a sequence, and define a curved line between the end points of the more than two consecutive points. For example, the electronic device can select five consecutive points detected by the device to represent a line, and construct a curved segment between the first and last of the five points. The electronic device can define one or more control points, and use one or more of the intermediate points to determine the shape of the Bezier curve between the end points. In some embodiments, the control points can be defined using a control line that defines a tangent at a sampled point of the curve.

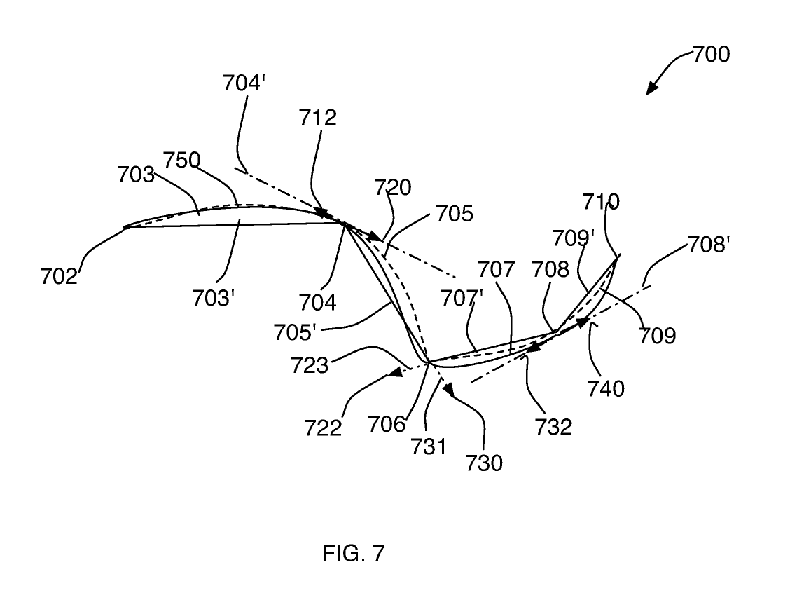

In some embodiments, a user can define a curve for which the user intends to have a sharp angle. In such cases, the electronic device may not apply a Bezier transform to segments preceding and following the sharp angle, or can instead or in addition revise the manner in which control points are defined in the vicinity of the sharp angle. FIG. 7 is a schematic view of a portion of a line having a sharp angle in accordance with one embodiment of the invention. Display 700 can include line 701 constructed from the combination of segments 703, 705, 707 and 709. Points 702, 704, 706, 708 and 710, which can be identified by sampling as a user provides an input corresponding to line 750, can define line 701. The electronic device can apply a transform to segments 703′, 705′, 707′ and 709′ to display, as the line is drawn, a curved line substantially matching the shape of line 750.

To determine whether an angle between adjacent segments corresponds to an intentionally sharp angle, the electronic device can calculate the angle between adjacent segments, and compare the angle to a threshold. In one implementation, the electronic device can identify the angles corresponding to points 704, 706 and 708, and compare the angles to a minimum angle size. Alternatively, the electronic device can compare pi minus the angle (or 180 degrees minus the angle) with a maximum threshold (e.g., to determine how close an angle is to a straight line). In some embodiments, the electronic device can consider an absolute value of an angle, if the angle is determined in a particular orientation (e.g., with a positive or negative value).

If the electronic device determines that the angle corresponds to an intentionally sharp angle, the electronic device can adjust control points in the vicinity of the angle. For example, the electronic device can merge the control points with the defined point corresponding to the peak of the angle. In the example of FIG. 7, control points for segments 705 and 707 at point 706 can be merged or substantially merged with point 706. In some embodiments, the electronic device can instead or in addition define distinct control lines that correspond to control points for each of segments 705 and 707 at point 706. For example, to define control point 722 corresponding to segment 705, the electronic device can define control line 723 as an extension of segment 707′ from point 706 moving away from point 708. Control point 722 can be selected at any suitable distance from point 706 along control line 723 including, for example, using one or more of the approaches described above. As another example, to define control point 730 corresponding to segment 707, the electronic device can define control line 731 as an extension of segment 705′ from point 706 moving away from point 704. Control point 730 can be selected at any suitable distance from point 706 along control line 731 including, for example, using one or more of the approaches described above.

In contrast, if the angle is determined to include an angle to be softened by transforms, the electronic device can define control lines and control points as described above in connection with the displays of FIGS. 5 and 6. In particular, the electronic device can define control point 712 for segment 703 and control point 720 for segment 705 using control line 704′, and control point 732 for segment 707 and control point 740 for segment 709 using control line 708′.

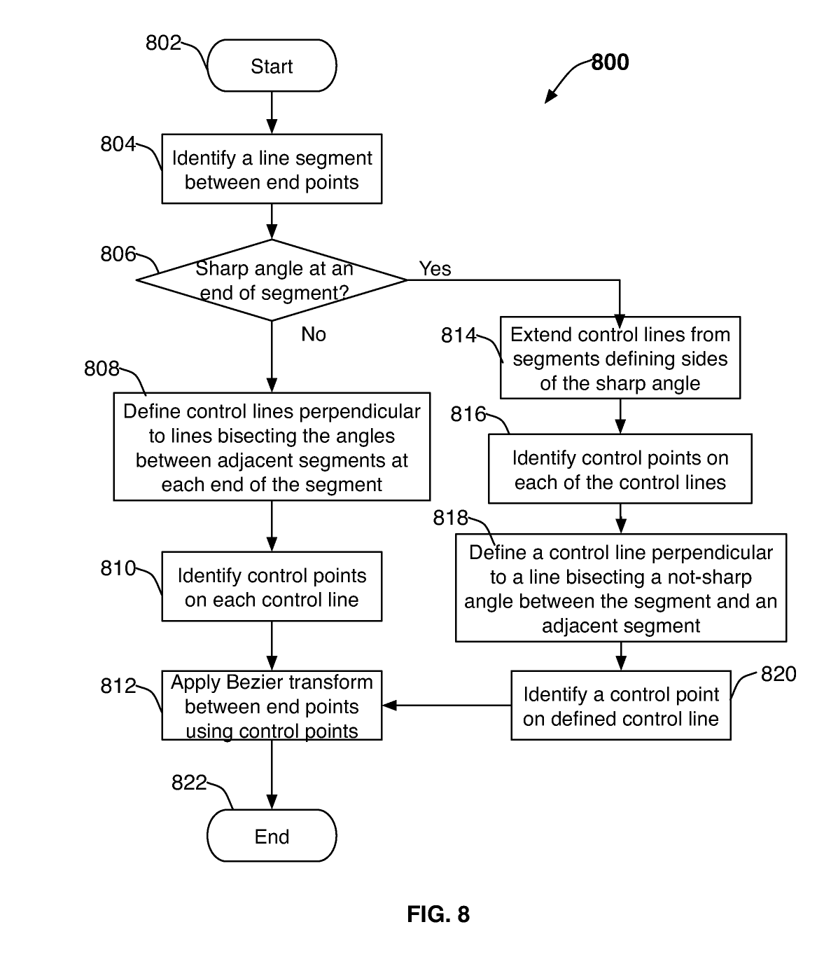

FIG. 8 is a flowchart of an illustrative process for applying a Bezier transform to a particular segment of a line in accordance with one embodiment of the invention. Process 800 can begin at step 802. At step 804, the electronic device can identify a line segment between end points. For example, the electronic device can select two consecutive sampled points defining a line. At step 806, the electronic device can determine whether there is a sharp angle at either end of the segment. For example, the electronic device can determine the angle between the segment and preceding and following segments, and compare the angle to a threshold. If the electronic device determines that there is no sharp angle at either end of the segment, process 800 can move to step 808.

At step 808, the electronic device can define control lines perpendicular to lines bisecting the angles between adjacent segments at each end of the segment. For example, the electronic device can identify the angles at each end of the segment, and define a line bisecting the angles. The electronic device can then define a control line that is perpendicular to the bisecting line, and that goes through an end of the segment. In some embodiments, the electronic device can instead or in addition define an extension of one of the segment and of an adjacent segment, and define a control line that bisects an angle between the extension and the other of the segment and the adjacent segment. By constructing control lines in this manner, the control lines can provide tangents to the line segment at the segment end points. At step 810, the electronic device can identify control points on each of the control lines. For example, the electronic device can define a point on the control line that is at a particular distance from the end point of the segment (e.g., a distance determined from a control value multiplied by a segment length). At step 812, the electronic device can apply a Bezier transform between the end points using the control points. For example, the electronic device can apply a quadratic Bezier transform. Process 800 can then move to step 822 and end.

If, at step 808, the electronic device instead determines that there is a sharp angle at an end of the segment, process 800 can move to step 814. At step 814, the electronic device can extend control lines from segments defining sides of the sharp angle. For example, the electronic device can define extensions for each of the two segments forming the sharp angle, such that the extensions extend away from the opposite end of the segment. At step 816, the electronic device can identify control points on each of the control lines. For example, the electronic device can define a point on the control line that is at a particular distance from the end point of the segment (e.g., a distance determined from a control value multiplied by a segment length). In some embodiments, the electronic device can only extend a control line from an adjacent segment defining a side of the sharp angle, as the extension of the segment may not serve to provide a control point for the transform of the segment (it may instead serve for the transform of an adjacent segment).

In some embodiments, the electronic device can instead of or in addition to one or both of steps 814 and 816, identify a control point at the end point of the segment forming the peak of the sharp angle. For example, a control point and an end point can be merged in the vicinity of the sharp angle. If angles at both ends of the segment are sharp, the electronic device can identify corresponding control points for both ends of the segment, and move directly to step 812.

At step 818, the electronic device can define a control line perpendicular to a line bisecting a not-sharp angle between the segment and an adjacent segment. For example, if an angle at another end of the segment is not sharp, the electronic device can define a control line for the end such that the control line is substantially tangent to the line segments at the other end of the segment (e.g., as described in step 808). At step 820, the electronic device can identify a control point on the control line. For example, the electronic device can define a point on the control line that is at a particular distance from the end point of the segment (e.g., a distance determined from a control value multiplied by a segment length). Process 800 can then move to step 812, described above.

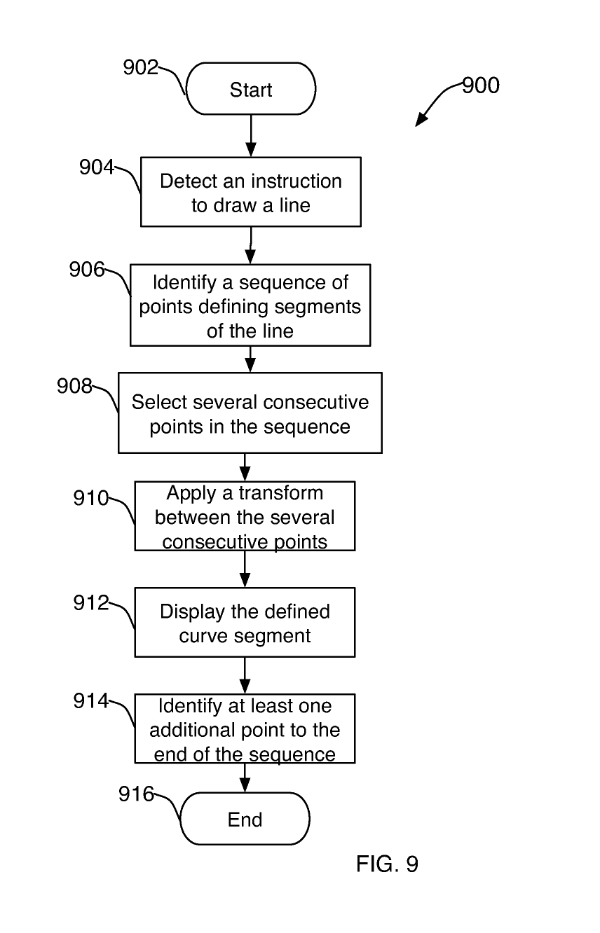

FIG. 9 is a flowchart of an illustrative process for displaying curved segments between points defining a line in accordance with one embodiment of the invention. Process 900 can begin at step 902. At step 904, the electronic device can detect an instruction to draw a line. For example, the electronic device can receive an input from an input interface of the device for drawing a line. At step 906, the electronic device can identify a sequence of points defining segments of the line. For example, the electronic device can sample individual points representing the line. At step 908, the electronic device can select several consecutive points of the sequence. For example, the electronic device can select two points between which a segment is drawn. At step 910, the electronic device can apply a transform between the consecutive points to define a curved segment extending between the points. For example, the electronic device can apply a Bezier transform between the points to define a curved segment. At step 912, the electronic device can display the defined curve segment to represent the line for which the user provided an instruction. For example, the electronic device can display the curved segment between the selected two points. At step 914, the electronic device can identify at least one additional point added to an end of the sequence of points. For example, the electronic device can identify an additional point corresponding to the line as the user continues to provide an input to the device. The at least one additional point can be identified after applying the transform to the selected two points. Process 900 can then end at step 916.

Although the preceding discussion described transforming segments between sampled points of a line, it will be understood that any other suitable approach can be used. In particular, the sampled points can instead or in addition serve as control points. In some embodiments, the electronic device can instead or in addition select center points or other points along a segment to serve as end points for a transformed line. Any portion of a defined point or segment can be used for a transform, so long as the transform can be applied and fixed for a portion of a line while the line is still being drawn.

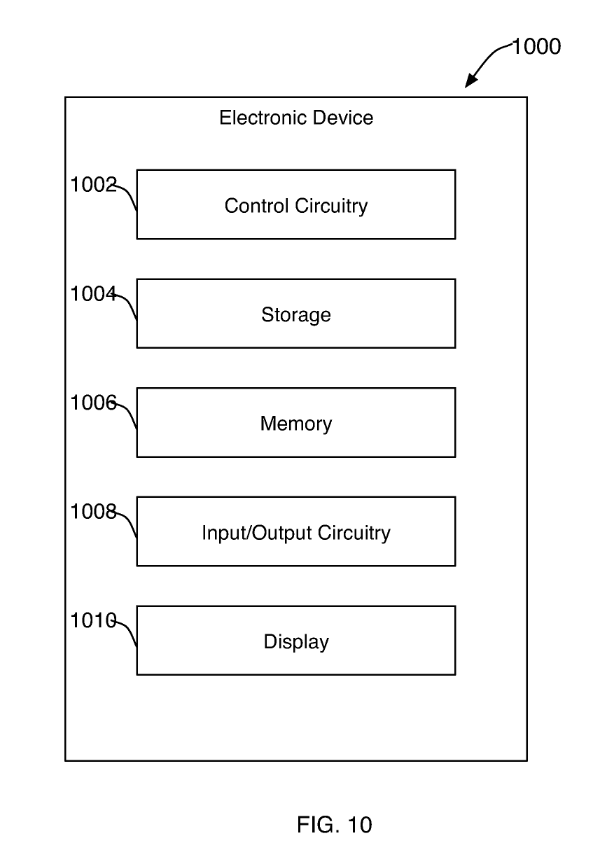

Any suitable electronic device can be used to dynamically smooth a curve drawn by a user. FIG. 10 is a schematic view of an illustrative electronic device in accordance with one embodiment of the invention. Electronic device 1000 can include any suitable type of electronic device operative to display information to a user. For example, electronic device 1000 can include a media player such as an iPod® available by Apple Inc., of Cupertino, Calif., a cellular telephone, a personal e-mail or messaging device (e.g., a Blackberry® or a Sidekick®), an iPhone® available from Apple Inc., pocket-sized personal computers, personal digital assistants (PDAs), a laptop computer, a music recorder, a video recorder, a gaming device, a camera, radios, medical equipment, and any other portable electronic device.

Electronic device 1000 can include a processor or control circuitry 1002, storage 1004, memory 1006, input/output circuitry 1008, and display 1010 as typically found in an electronic device of the type of electronic device 1000, and operative to enable any of the uses expected from an electronic device of the type of electronic device 1000 (e.g., connect to a host device for power or data transfers). In some embodiments, one or more of electronic device components 1000 can be combined or omitted (e.g., combine storage 1004 and memory 1006), electronic device 1000 can include other components not combined or included in those shown in FIG. 10 (e.g., communications circuitry or positioning circuitry), or electronic device 1000 can include several instances of the components shown in FIG. 10. For the sake of simplicity, only one of each of the components is shown in FIG. 10.

Control circuitry 1002 can include any processing circuitry or processor operative to control the operations and performance of electronic device 1000. Storage 1004 can include, for example, one or more storage mediums including a hard-drive, solid state drive, flash memory, permanent memory such as ROM, any other suitable type of storage component, or any combination thereof. Memory 1006 can include cache memory, semi-permanent memory such as RAM, and/or one or more different types of memory used for temporarily storing data. In some embodiments, memory 1006 and storage 1004 can be combined as a single storage medium. Input/output circuitry 1008 can be operative to convert (and encode/decode, if necessary) analog signals and other signals into digital data. Input/output circuitry 1008 can be coupled to or include any suitable input interface, such as for example, a button, keypad, dial, a click wheel, or a touch screen, as well as any suitable output circuitry associated with output devices (e.g., audio outputs or display circuitry or components).

Display 1010 can be operatively coupled to control circuitry 1002 for providing visual outputs to a user. Display 1010 can include any suitable type of display, including for example a liquid crystal display (LCD) (e.g., active matrix, passive matrix and the like), a monochrome display, color graphics adapter (CGA) display, enhanced graphics adapter (EGA) display, variable-graphics-array (VGA) display, super VGA display, cathode ray tube (CRT), a plasma display, a display implemented with electronic inks, or any other suitable display. Display 1010 can be configured to display a graphical user interface that can provide an easy to use interface between a user of the computer system and the operating system or application running on the system.

In some embodiments, electronic device 1000 can include a bus operative to provide a data transfer path for transferring data to, from, or between control processor 1002, storage 1004, memory 1006, input/output circuitry 1008, display 1010 and any other component included in the electronic device.

Although many of the embodiments of the present invention are described herein with respect to personal computing devices, it should be understood that the present invention is not limited to personal computing applications, but is generally applicable to other applications.

The invention is preferably implemented by software, but can also be implemented in hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, and optical data storage devices. The computer readable medium can also be distributed over network-coupled computer systems so that the computer readable code is stored and executed in a distributed fashion.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The above described embodiments of the invention are presented for purposes of illustration and not of limitation.

What is claimed is:

1. A method for dynamically smoothing a curve, comprising:
detecting an instruction to draw a line;
identifying a sequence of points defining the line;
selecting a plurality of consecutive points in the sequence;
applying a transform between the consecutive points to define a curved segment between the two consecutive points;
displaying the defined curve segment to represent the line; and
detecting additional instructions to continue drawing the line after applying the transform.

2. The method of claim 1, further comprising:
storing the defined curved segment in cache as part of a line definition.

3. The method of claim 2, further comprising:
determining that the selected two consecutive points are not among the last points of the sequence; and
wherein storing further comprises storing the defined curved segment in response to determining.

4. The method of claim 3, wherein determining further comprises:
determining that the selected two consecutive points are within a threshold number of the last points of the sequence.

5. The method of claim 1, wherein detecting an instruction further comprises:
detecting an instruction received using an input interface to draw the line.

6. The method of claim 1, wherein identifying a sequence of points further comprises:
sampling the detected instruction at a particular rate to identify the sequence of points corresponding to the line for which the instruction was detected.

7. The method of claim 6, wherein sampling further comprises:
sampling at pre-determined time intervals.

8. The method of claim 1, further comprising:
identifying at least one control point corresponding to the selected two consecutive points; and
wherein applying a transform further comprises applying the transform using the identified at least one control point to control the curvature of the defined curved segment.

9. The method of claim 8, further comprising:
determining that an angle of the line at a particular point of the sequence is smaller than a threshold; and
merging the at least one control point corresponding to the particular point of the sequence with the particular point of the sequence.

10. An electronic device for dynamically adjusting a line, comprising control circuitry, the control circuitry operative to:
identify a sequence of points corresponding to a user instruction to define a line;
direct a display to display a plurality of curved segments between adjacent points of the identified sequence of points, wherein each of the curved segments is defined by applying a transform to the adjacent points of the curved segments;
identify a new point corresponding to a recently received user instruction to continue defining the line;
identify at least one of the plurality of curved segments for which the applied transform was incompletely applied; and
completely apply the transform to the identified at least one of the plurality of curved segment using information derived from the identified new point.

11. The electronic device of claim 10, wherein the control circuitry is further operative to:
sample positions of an input provided to an input interface to identify the sequence of points that correspond to the user instruction to define the line.

12. The electronic device of claim 10, wherein the control circuitry is further operative to:
completely apply the transform to at least one pair of adjacent points of the identified sequence to define a complete curved segment; and
store the complete curved segment in storage, wherein the transform is not applied again to the at least one pair of adjacent points for which a complete curved segment is defined.

13. The electronic device of claim 12, wherein the control circuitry is further operative to:
define at least one control point for applying the transform, wherein the control point is defined based on at least one of a point of the identified sequence of points preceding or following the at least one pair of adjacent points; and
using the defined at least one control point to apply the transform.

14. The electronic device of claim 13, wherein the control circuitry is further operative to:
define a control line substantially perpendicular to a line bisecting an angle defined between a straight segment extending between the at least one pair of adjacent points and a straight segment extending between one of the at least one pair of adjacent points and a point adjacent to the one of the at least one pair of adjacent points; and
select a distance on the control line from the one of the at least one pair of adjacent points for positioning the at least one control point.

15. The electronic device of claim 14, wherein the control circuitry is further operative to:
apply a quadratic Bezier transform between the at least one pair of adjacent points, wherein the at least one control point determines the curvature of the quadratic Bezier transform.

16. A method for smoothing a curve as it is defined, comprising:
identifying a sequence of at least three points corresponding to a line defined from a user input, wherein the at least three points form at least two pairs of points ordered as they are identified in the sequence;
applying a transform to each ordered pair of points within the sequence, wherein the transform defines a curved segment connecting each ordered pair;
identifying an additional point for the sequence, wherein the additional point corresponds to an extension to the line defined from the user input;
retrieving information corresponding to the identified additional point, wherein the information is used by the transform; and
re-applying the transform to each ordered pair of points using the retrieved information to more accurately represent the line defined by the user input.

17. The method of claim 16, further comprising:
identifying an ordered pair for which the applied transform does not change with the retrieved information; and
storing the defined curved segment for the identified ordered pair in cache.

18. The method of claim 16, further comprising:
identifying ordered pairs for which the applied transform changes with received information; and
re-applying the transform only to the identified ordered pairs for which the applied transform changes with received information.

19. The method of claim 16, wherein:
the transform comprises a Bezier transform.

20. Computer readable media for dynamically smoothing a curve, comprising computer readable code recorded thereon for:
detecting an instruction to draw a line;
identifying a sequence of points defining the line;
selecting two consecutive points in the sequence;
applying a transform between the consecutive points to define a curved segment between the two consecutive points;
displaying the defined curve segment to represent the line; and
identifying at least one additional point added to an end of the sequence of points, wherein the at least one additional point is identified after applying the transform.
